(19) United States
(12) Patent Application Publication
(10) Pub. No.: US 2012/0075676 A1
(43) Pub. Date: Mar. 29, 2012

(54) LAYOUT SYSTEM, INFORMATION PROCESSING APPARATUS, LAYOUT METHOD, AND PROGRAM THEREOF

(75) Inventor: Yusuke Komoto, Kawasaki-shi (JP)

(73) Assignee: CANON KABUSHIKI KAISHA, Tokyo (JP)

(21) Appl. No.: 13/232,620

(22) Filed: Sep. 14, 2011

(30) Foreign Application Priority Data
Sep. 27, 2010 (JP) 2010-215088

(51) Int. Cl. G06K 15/02

(52) U.S. Cl. 358/1.18

(57) ABSTRACT

A layout system performs layout on a printed document to readily and uniformly treat a plurality of types of print products, and performs the layout on content of a document using a template associated with a design theme to be applied to the plurality of types of print products associated with a usage of the printed document.

### BACKGROUND OF THE INVENTION

1. Field of the Invention

The present invention relates to a layout system that performs layout on a printed document.

2. Description of the Related Art

Along with the Internet becoming more popular and increasing its speed, a print order system (hereinafter, referred to as a “web to print system”) is being developed. By using the web to print system, an uploading operation can be computerized, and thus a print order and print processing (work flow) can be performed with high efficiency.

In the web to print system, a user conducts a print order as follows. First, the user selects a print product. The print product represents a product that is a basic unit of the order and includes business cards, post cards, A4 saddle stitch booklets, and A3 posters.

Next, content (e.g., text and an image) to be printed is uploaded. Subsequently, the user selects a template previously prepared on the web to print system. In the template, normally, a variable region (place holder) in which the user can specify the content is set. The user uploads the content, and then specifies which content is applied to which place holder to perform layout.

Then, the user specifies an option that can be specified for each product. The option that can be specified for each product includes, for example, a type of sheet and the number of copies of the sheet.

Finally, the user specifies an option that can be specified for each print order. The option that can be specified for each print order includes, for example, how to receive the product and how to make settlement.

Upon receiving a notification of receiving the print order, a printing company prints the uploaded content of the print product according to the option specified by the user. Upon completing printing, the printing company delivers the print product to the user by the method specified by the user and makes settlement specified thereby. The web to print system and the print processing (work flow) operated by the printing company cooperate with each other to perform the processing described above with a higher efficiency.

Various types of techniques are provided for assisting the user to select the above-described template. For example, Japanese Patent Application Laid-Open No. 2006-309397 discusses a technique for assisting the user to select the template. According to the technique, attribute information about a printer, an output form such as a paper size, and a usage classification of the printing result has been previously associated with one another for each template, and then the template associated with the attribute information selected by the user is suggested to the user.

In the conventional web to print system, when the user is to conduct an order of a plurality of different types of print products, the user needs to repeatedly perform ordering processing (selecting a product and a template, uploading content, specifying an option for each layout and product) for each print product. At this point, when design and taste are to be uniformed among a plurality of types of print products, the user needs to create the document to be uploaded and select the template with consciousness of uniformity. Further, even when the user is to use the common content among the different types of print products, the user also needs to upload and specify the content for each print product.

When the technique for assisting the selection of the template, for example Japanese Patent Application Laid-Open No. 2006-309397 is used, if the design and the taste are previously defined as the attribute information, the template including the same design and the same taste can be readily selected. However, still a problem remains in which the ordering processing needs to be repeatedly performed for the plurality of types of print product.

### SUMMARY OF THE INVENTION

An aspect of the present invention is directed to a layout system that can readily and uniformly deal with a plurality of types of print products.

According to an aspect of the present invention, a layout system that performs layout on a printed document includes a determination unit configured to determine a usage of the printed document, a first selection unit configured to select a design theme to be applied to a plurality of types of print products associated with the determined usage, and a layout unit configured to perform the layout on content of a document using a template associated with the design theme selected for the print product.

According to exemplary embodiments of the present invention, when performing layout on a printed document, the same design and the same taste can be uniformly applied to a plurality of different types of print products associated with a usage of the printed document.

Further features and aspects of the present invention will become apparent from the following description of exemplary embodiments in detail with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a web to print system (layout system).

FIG. 2 illustrates an example of a configuration of a computer apparatus according to an exemplary embodiment of the present invention.

FIG. 3 illustrates an example of shift of print order screens according to the exemplary embodiment of the present invention.

FIGS. 4A, 4B, 4C, 4D, and 4E illustrate examples of print order screens in detail.

FIGS. 5A and 5B illustrate examples of table data according to the exemplary embodiment of the present invention.

FIGS. 6A and 6B illustrate examples of print order screens in detail.

FIG. 7 is flowcharts illustrating print order processing.

FIG. 8 illustrates an example of an event selection screen and a design theme selection screen according to a second exemplary embodiment of the present invention.

FIG. 9 illustrates an example of a data table in which an event is associated with a design theme according to the second exemplary embodiment.

FIG. 10 is a flowchart illustrating design theme selection processing according to the second exemplary embodiment.

FIG. 11 is a flowchart illustrating a design theme selection processing according to a third exemplary embodiment.

FIGS. 12A and 12B illustrate examples of data tables according to the third exemplary embodiment.

### DESCRIPTION OF THE EMBODIMENTS

Various exemplary embodiments, features, and aspects of the invention will be described in detail below with reference to the drawings.

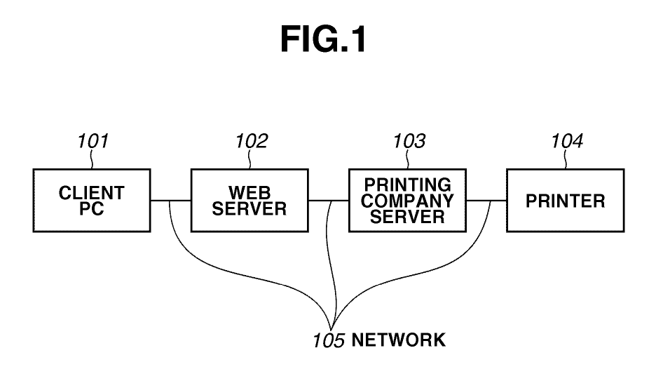

FIG. 1 illustrates a configuration of a web to print system (layout system) according to an exemplary embodiment of the present invention. The web to print system includes a client personal computer (PC) 101, a web server 102, a printing company server 103, and a printer 104, which are connected to one another via a network 105.

The client PC 101 is an information processing apparatus that transmits data input by a user to the web server 102 and receives the data therefrom.

The web server 102 is an information processing apparatus that receives the data from the client PC 101, processes the received data, and then transmits the processed data to the client PC 101 or the printing company server 103.

The printing company server 103 has functions for processing the data for realizing printing work flow and creating the data. Further, the printing company server 103 is an information processing apparatus that transmits/receives the data to/from the web server 102, performs various types of processing, and transmits the print data to the printer 104.

The printer 104 receives the print data created by the printing company server 103 and performs printing. As described above, in the web to print system, the user can conduct a print order from the client PC 101 via the network 105.

According to the exemplary embodiment of the present invention, the client PC 101 is defined as a PC. However, the present invention is not limited thereto. A mobile phone, a smartphone, a personal digital assistance (PDA), or a net book may be also used. In other words, any information processing apparatus can be used as long as it can be connected to the network using a web browser.

Further, according to the exemplary embodiment of the present invention, the web server 102 and the printing company server 103 are connected to each other via the network 105. However, one computer may be used in place of the two servers. Regarding transmission/reception of the data between the web server 102 and the printing company server 103, the data is transmitted from the web server 102 to the printing company server 103. However, the printing company server 103 may periodically make an inquiry at the web server 102.

Furthermore, the system configuration illustrated in FIG. 1 is merely an example. Each element may be formed of a plurality of devices, or each element maybe formed of a single device.

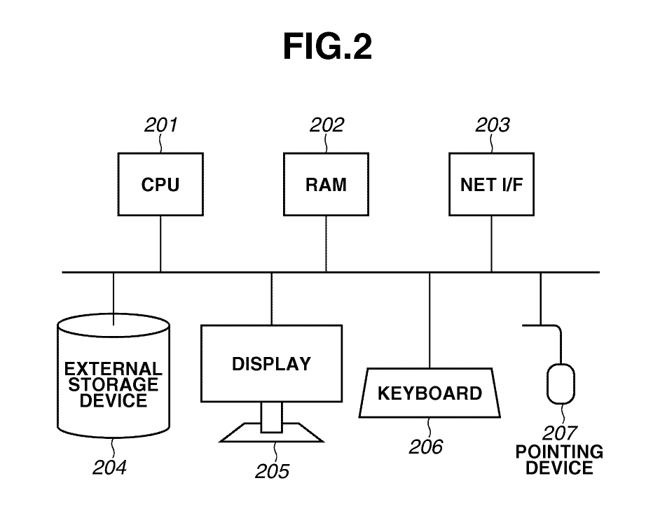

Next, FIG. 2 illustrates a configuration of a computer apparatus (information processing apparatus) according to the exemplary embodiment of the present invention. FIG. 2 illustrates an example of a configuration of the client PC 101, the web server 102, and the printing company server 103.

A central processing unit (CPU) 201 performs a control program stored in a random access memory (RAM) 202 to control the whole apparatus.

The RAM 202 reads and stores a control program of the apparatus for realizing a flowchart described below and data such as a document and an image as a work memory of the CPU 201.

A network interface (NET I/F) 203 transmits/receives the data to/from an external apparatus via the network 105 under control of the CPU 201.

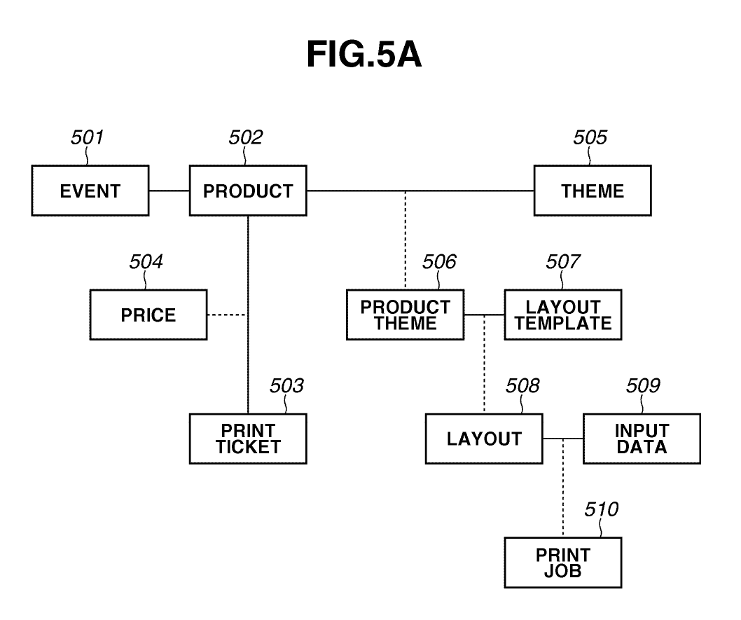

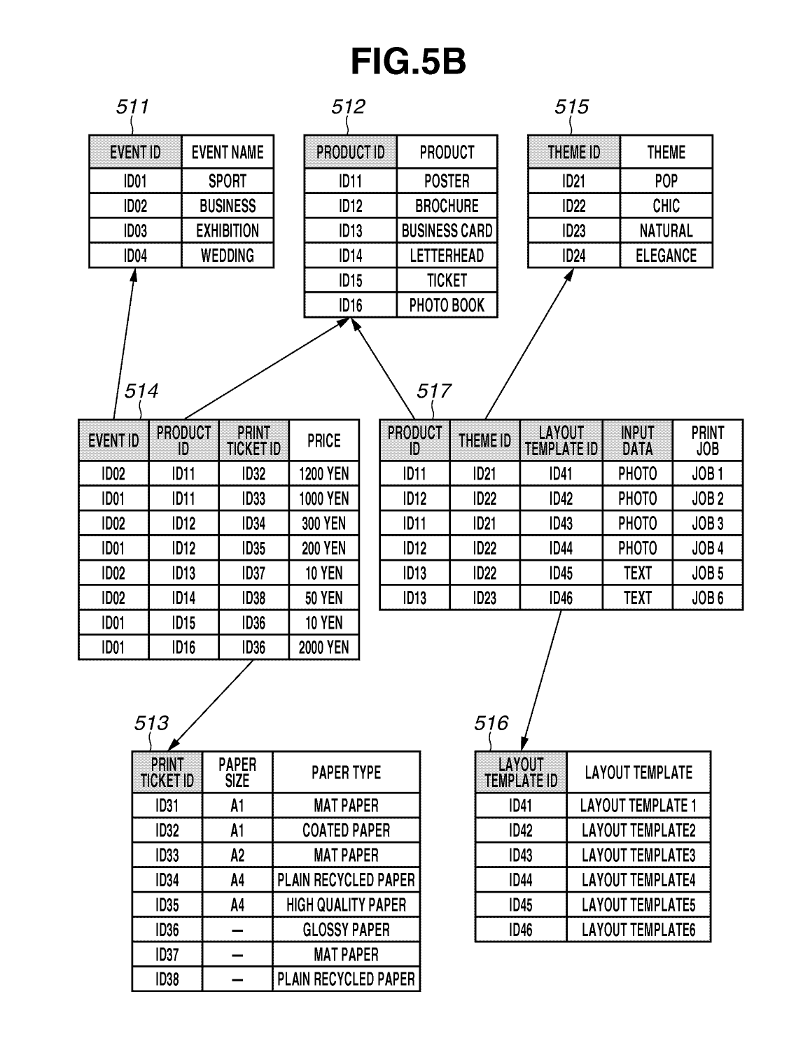

An external storage device 204 is a magnetic disk that stores various types of data and a control program of the apparatus for realizing the flowchart described below executed by the CPU 201. The external storage device 204 of the web server 102 stores the data table illustrated in FIG. 5B described below.

FIG. 2 illustrates a display 205, a keyboard 206, and a pointing device 207 such as a mouse.

A program stored in the external storage device 204, in order to perform a predetermined operation, uses a function of an operating system (OS) also stored in the external storage device 204 as necessary.

Further, the RAM 202 reads the program stored in the external storage device 204 so that the CPU 201 can execute the program. The CPU 201 executes processing of information and control of the apparatus that performs reading/writing of the content of the data temporarily stored in the RAM 202 based on the control program, reading/writing of the data in the external storage device 204, and transmission/reception of the data via the NET I/F 203.

Furthermore, the CPU 201 receives input from the keyboard 206 and the pointing device 207, and controls display on the display 205.

The external storage device 204 of the client PC 101 stores a web browser program. The CPU 201 of the client PC 101 reads the web browser program to the RAM 202 to execute it.

The client PC 101 receives the input from the keyboard 206 or the pointing device 207 based on the web browser program, and transmits a request to the web server 102 via the NET I/F 203. The client PC 101 receives a response from the web server 102 via the NET I/F 203 based on the web browser program, and then displays the response on the display 205.

The external storage device 204 of the web server 102 stores a web to print program. The RAM 202 stores the web to print program so that the CPU 201 of the web server 102 can executes the web to print program. Based on the web to print program, upon receiving the request from the client PC 101, the web server 102 processes the data and creates the processing result on the RAM 202.

Further, the web server 102, based on the web to print program, via the NET I/F 203, transmits the processing result to the client PC 101 or the printing company server 103.

The external storage device 204 of the printing company server 103 stores the program for processing and creating the data for realizing the printing work flow. Based on the program, the printing company server 103 processes the data received from the web server 102 and creates the processing result on the RAM 202.

Further, the printing company server 103 transmits the print data, which is the processing result, to the printer 104 via the NET I/F 203.

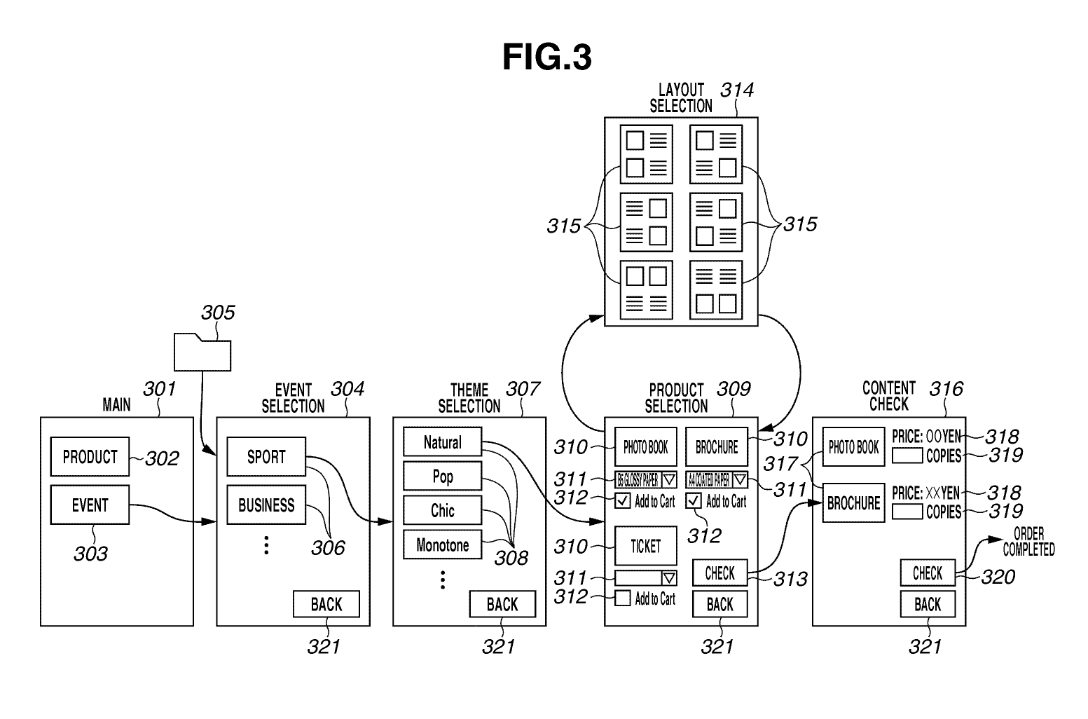

Subsequently, using the web to print system (layout system) according to the present exemplary embodiment described above, a concept of shift of the print order screen displayed on the client PC 101 when the print order is conducted will be described with reference to FIG. 3.

The web browser of the client PC 101 receives an operation instruction form the user, converts the operation instruction into a request, and then transmits the request to the web server 102. The web server 102, based on the web to print program, processes the request from the client PC 101 and transmits a response to the client PC 101.

Upon receiving the response from the web server 102, the web browser of the client PC 101 converts the response into a format that can be displayed on a screen, and then displays an ordering screen illustrated in FIG. 3 on the display 205 of the client PC 101.

A screen 301 is the first screen via which the user conducts the print order. Via this screen, either one of the ordering methods is selected by specifying the print product (hereinafter, referred to as simply “product”) or by specifying an event for which the product is used to conduct the order of the product related to the event.

The print product represents a product that is a basic unit of the order and includes photo books, business cards, post cards, booklets, and posters.

In the method for ordering by specifying the product, the user specifies the desired product from among the plurality of types of products. Next, the user selects the template, and uploads the content of a document. Finally, the option is set for each product, and then the order is determined. When the desired print product is obvious and the user desires one type of the product, the user selects an ordering method from the product.

A button (link) 302 is used to conduct an order by specifying the product. A button (link) 303 is used to conduct an order of the product by selecting the event. When the user selects either of the button operations, the ordering method can be specified.

When the user operates the button 303, the client PC 101 transmits a notification of the operation to the web server 102 as a request, and then the web server 102 returns a request for displaying a screen 304 to the client PC 101 as a response. The web browser of the client PC 101 shifts the screen 301 to the screen 304 based on the received request.

In the product ordering method, the user can readily conduct the order of print products based on the usage of the printed document. Further, the order of the plurality of types of print products associated with the usage of the printed document can be readily conducted. Moreover, since the user can select and specify either of the ordering method by specifying the print product and the ordering method by specifying the event (usage of the printed document) to conduct the order of the product related to the event, the ordering method desired by the user can be provided.

Via the screen 304, the user selects the event to specify the usage of the printed document. The event used here defines in what situation the printed document is used (usage) . For example, an event such as a sport event and a business event can be selected to determine the usage of the printed document.

Further, via this screen, the user can upload content 305 of the document including text and an image. Event buttons 306 select each event. When the user operates either of the event buttons 306 to specify the event, the screen 304 shifts to a screen 307.

Via the screen 307, the user can select a design and a taste (hereinafter, referred to as a “theme”) to be uniformly applied to the product. Via this screen, a design theme, for example, natural, pop, chic, or monotone, is selected. The design theme used here means that the design of patterns, shapes, colors and so forth has uniformity. In other words, the template suggested to the plurality of types of products described below has the uniformity in the design theme (design including patterns, shapes, colors and so forth).

According to the present exemplary embodiment, the content 305 uploaded via the screen 304 is used for characters and images to be uniformly used for the plurality of types of products. Further, the characters and the images to be uniformly used for the plurality of types of products may be defined due to the design theme.

Design theme buttons 308 select each design theme. When the user operates any of the design theme buttons 308, the screen 307 shifts to a screen 309.

The design theme associated with the event (usage of the printed document) selected via the screen 304 may be suggested. For example, according to the event selected via the screen 304, the design theme previously associated with the selected event is displayed on the screen 307. In other words, in the screen 307, a type of a design theme 308 that can be selected depending on the event selected via the screen 304 is changed. With this arrangement, the design theme that is appropriate for the event can be recommended to the user.

Via the screen 309, the user selects and specifies the product to be ordered from the plurality of types of products previously associated with the events selected via the screen 304. The products that can be readily used for the events selected via the screen 304 are displayed, as a plurality of types of products displayed on the screen 309. In other words, on the screen 309, the type of the product that can be selected depending on the event selected via the screen 304 is changed.

Via the screen 309, the user selects the product to be ordered, and the option for each product is set. Layout buttons 310 display brief of the product and also select layout. Drop down list boxes 311 each set the option such as the size and the type of the paper for each product. Check boxes 312 set whether to order the product. A check button 313 shifts the screen 309 to a screen 316 for checking the order of the selected product.

The drop down list box 311 is not limited to a form of a pull down menu but may be a form for selecting the option using the check box or a form for directly inputting the option. When the user operates any of the layout buttons 310, the screen 309 shifts to the screen 314. When the user operates the check button 313, the screen 309 shifts to the screen 316.

Via a screen 314, the user selects the layout. Via this screen, the user selects the desired layout from among candidates of layout results displayed in a list. The layout result of the layout performed on the content 305 uploaded via the screen 304 is suggested as a candidate. The template to be used for the layout is associated with the product or the design theme selected via the screen 307.

When the user operates any of the layout buttons 310 of the products on the screen 309, a layout candidate on which the design theme selected via the 307 is reflected is suggested even if the screen 309 shifts to the screen 314. Buttons 315 select the layout. When the user operates any of the buttons 315, the screen 314 shifts to the screen 309 again.

Via the screen 316, the user checks a price of the product selected via the screen 309 and inputs the number of copies of the product. Regions 317 are to display the selected product and option information thereabout. Fields 318 are to display unit price information about the selected product. In fields 319, the number of copies of the selected product is to be input. A button 320 is to confirm the order. When the user operates the order button 320, the order is confirmed.

A back button 321 is to shift the screen back to one previous screen. The back button 321 is included in each of the screens 304, 307, 309, and 316. When the user operates the back button 321 on each screen, the screen shifts back to each of one previous screens 301, 304, 307, and 309, respectively.

Upon receiving the request of the order confirmation from the web browser of the client PC 101, the web server 102 creates the print job from the request and transmits it to the printing company server 103.

As described above, the user uses the web to print system from the client PC 101 to conduct the print order.

Subsequently, table data will be described that has been previously held by the web server 102 and is to be referred to when creating the response for displaying the screen on the client PC 101 illustrated in FIG. 3.

FIGS. 5A and 5B illustrate examples of the table data used when the web to print program of the web server 102 is performed. FIG. 5A schematically illustrates relationships among gathering of the data.

An event 501 represents gathering of events such as a sport event, a business event, and an exhibition event, where the printed document is used. A product 502 represents gathering of the product such as posters, brochures, photo books, tickets, business cards, and envelops.

The event can be associated with the plurality of types of products. In other words, the product having a prospective demand can be defined in association with each event (for each usage). As a result, the product appropriate for the usage of the printed document can be recommended and suggested to the user.

A print ticket 503 represents gathering of print information about a size and a type of paper, how to fold and how to bind the paper. A price 504 is gathering of price information determined from a combination of the product 502 and the print ticket 503. The gathering of the price information indicates that, when the print ticket 503 is determined for a certain product, the price 504 is also determined.

A design theme 505 represents gathering of the design themes (e.g., natural, pop, chic, and monotone) that can be applied to the product. The design theme 505 defines the design and the taste to be applied to the plurality of types of products.

When the design theme is determined for a certain product, there is a plurality of layout templates 507 that can be applied to a determined product theme 506. The layout template 507 represents gathering of the templates in which an arrangement of figures and text is determined. In other words, the product theme 506 and the layout template 507 associated therewith can be defined.

Further, when either of the product theme 506 and the layout template 507 associated therewith is selected, a layout 508 is defined. Input data 509 that is the content including the text and the image to be uploaded by the user is applied to the layout 508 to create a print job 510.

FIG. 5B illustrates an example of the table data. A table 511 defines the event 501 that is the usage of the printed document when the user conducts the print order. The table 511 defines an event name and an event identification (ID) corresponding thereto. The events include, for example, a sport event, a business event, an exhibition event, and a wedding.

A table 512 defines the product 502 that can be ordered by the system according to the present exemplary embodiment. The table 512 defines a product ID and a product corresponding thereto. The products include, for example, a poster, a brochure, a photo book, a ticket, a business card, and an envelope.

A table 513 defines the print ticket 503. The table 513 defines a print ticket ID and a size and a type of paper corresponding thereto.

A table 514 defines a price 504 from relationships among the event 501, the product 502, and the print ticket 503. The table 514 defines an event ID, a product ID, and a print ticket as external keys for main keys of the table 511, the table 512, and the table 513 respectively. By the table 514, a plurality of types of products can be associated with an event.

Further, the web server 102 can acquire information about the product associated with the event. For example, in order to acquire the information about the product associated with the sport event, data is extracted using, as a key, the event ID “ID01” of the sport event from the table 514. Herein, “ID11”, “ID12”, “ID15”, and “ID16” are defined as product IDs associated with “ID01”.

Further, with reference to the table 512, the web server 102 can determine that “poster”, “brochure”, “ticket”, and “photo book” are associated with the sport event.

Further, in the table 514, the price 504 can be acquired from the relationships among the event 501, the product 502 and the print ticket 503. For example, when the user conducts the order using the system according to the present exemplary embodiment, if “sport” having ID01 is selected as the event, “poster” having ID11 is selected as the product, and the print setting having ID33 is selected for the print ticket, the price is defined as 1,000 Yen from the table 514.

A table 515 defines the design theme 505. The table 515 defines a design theme ID and a design theme corresponding thereto. A table 516 defines the layout template 507.

A table 517 defines the relationships among the product, the design theme, and the layout template. The product and the design theme to be used for the layout template have been previously allocated. Further, the table 517 defines a print job from the relationships among the product, the design theme, and the layout template input data (input content).

For example, when “poster” of the product ID “ID11”, “pop” of the design theme ID “ID21”, and “layout template 1” of the layout template ID “ID41” are selected, a layout is defined. If the input data input by the user is applied to the defined layout, print job creation processing can be performed, and then the print job is defined.

The web server 102 has previously defined and held the tables 511 to 517 to perform the exemplary embodiment according to the present invention.

A data table in which the event and the design theme are associated with each other may be held. In other words, the design theme associated with the event selected via the screen 304 can be suggested via the screen 307. The design theme corresponding to the event can be selected so that the design theme appropriate for the usage of the printed document can be recommended to the user.

Further, according to the present exemplary embodiment, the data is treated in a relational database (RDB) format. However, the present invention is not limited thereto. The data format maybe an extensible markup language (XML) data or a computerized system validation (CSV) file.

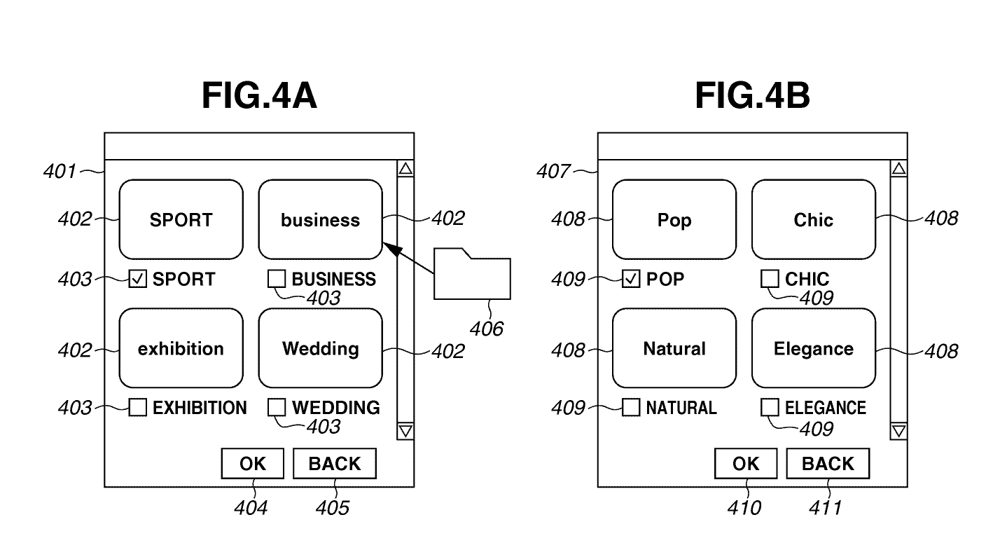

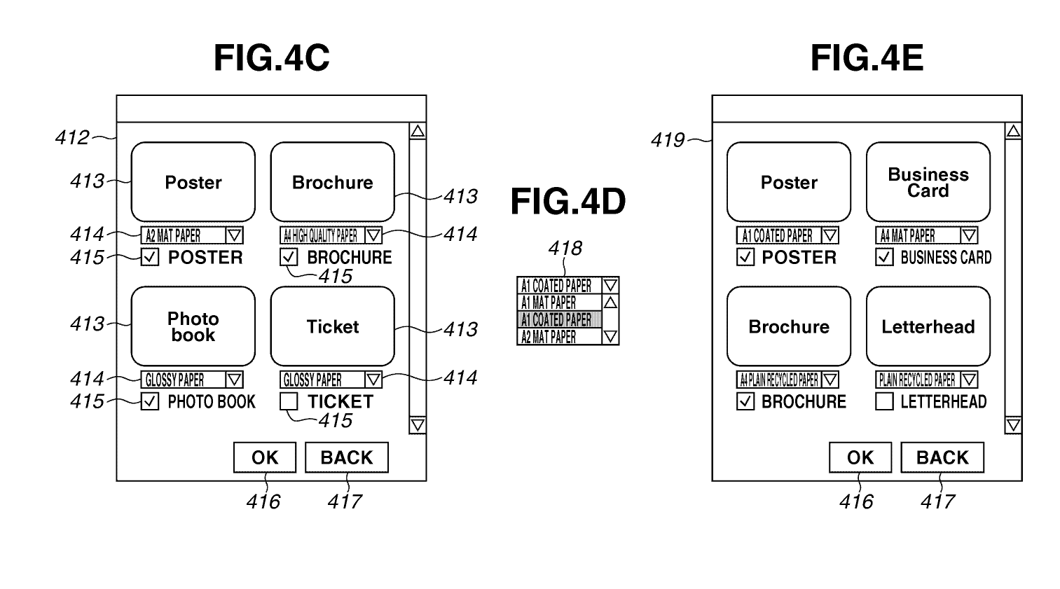

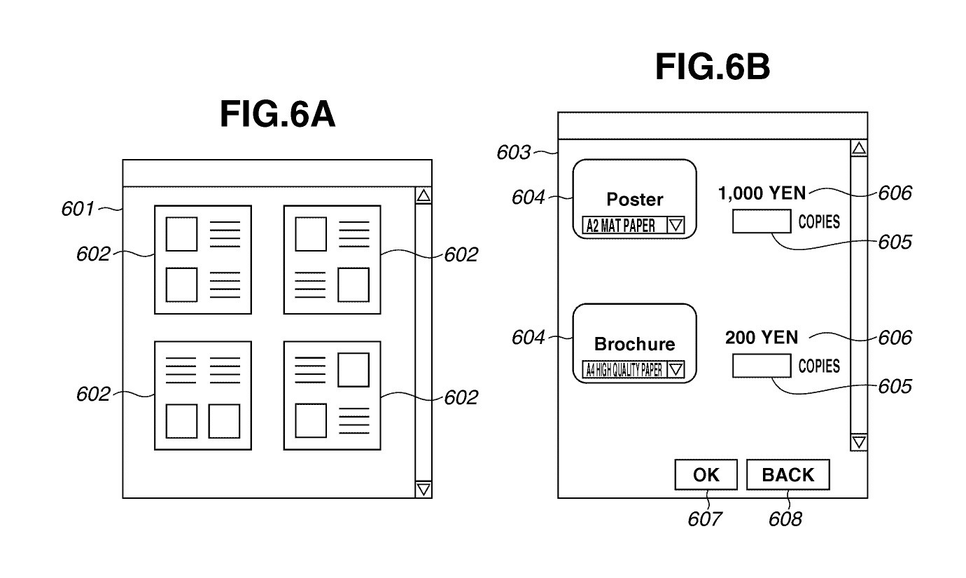

With reference to figures, operations of the web to print system (layout system) using the above-described configuration will be described in detail. Further, with reference to FIGS. 4A through 4E and FIGS. 6A and 6B, which illustrate details of an example of each print order screen illustrated in FIG. 3, the details will be described.

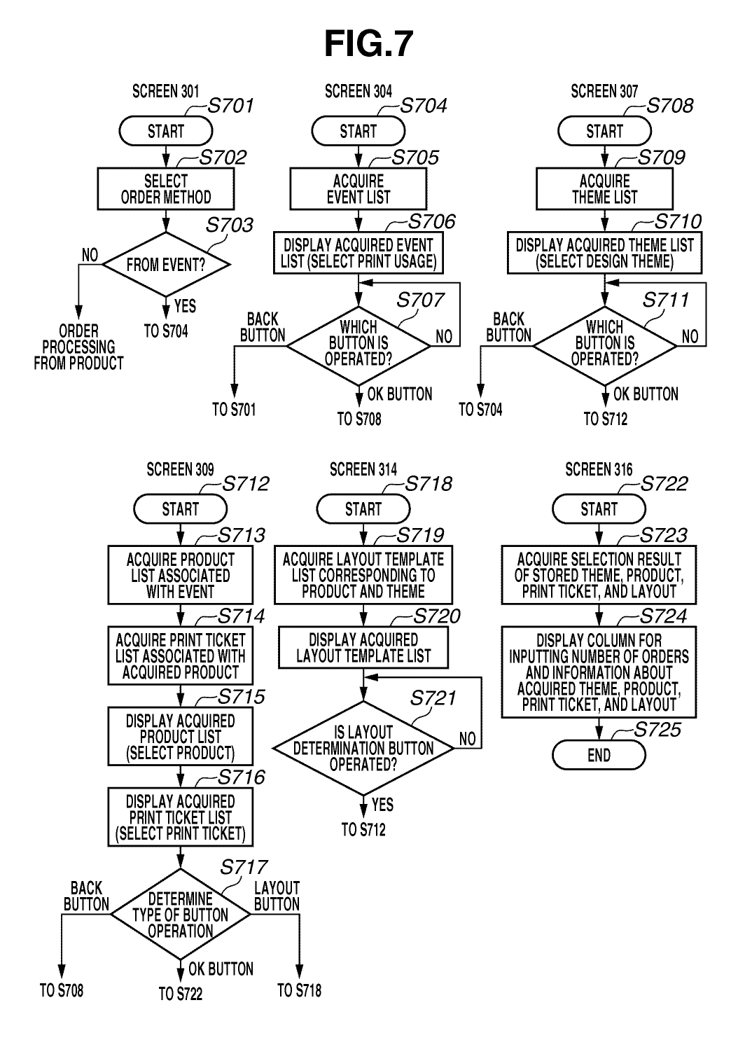

FIG. 7 is a flowchart illustrating processing performed by the client PC 101 and the web server 102 in the print order processing. A flow from step S701 to step S703 is processing performed on the screen 301 illustrated in FIG. 3.

In step S701, the processing starts. The client PC 101 transmits a request to the web server 102 via the web browser.

In step S702, the client PC 101 receives its response from the web server 102. The web browser running on the client PC 101 converts the response into the format that can be displayed on the screen and displays the converted response. Herein, a button is displayed for selecting and specifying, as an ordering method, either of the method for conducting an order by directly specifying a product and the method for conducting an order from an event.

In step S703, the web browser running on the client PC 101 determines which button of the buttons 302 and 303 on the display screen has been operated. When the button 303 for conducting the order from the event has been selected (YES in step S703), the processing proceeds to step S704. When the button 302 has been selected (NO in step S703), the processing for conducting the order from the product is started. However, the processing of this case is not described in detail herein.

Processing performed on the screen 304 is described in a flow from step S704 to step S707. In step S704, the processing is started. The web browser running on the client PC 101 transmits to the web server 102 a request notifying the user's input via the screen 301. The web server 102 stores the input as session information in the RAM 202 or the external storage device 204.

In step S705, when the web server 102 determines that, with reference to the session information, the method for conducting the order from the event is specified, an event list is acquired from the table 511 stored in the external storage device 204. Based on the table 511, the web server 102 creates a response to display the event list.

In step S706, the web browser running on the client PC 101 receives the response from the web server 102, converts the response into the format that can be displayed on the screen, and then displays the converted response.

FIG. 4A illustrates a screen displaying the event list illustrated in the screen 304 in detail. A screen 401 is an example for selecting an event illustrated in the screen 304.

Regions 402 display event information. The regions 402 display event names stored in the table 511. Further, using the pointing device 207, the user drags and drops into the region 402 the content 406 of a document including text and an image stored in the external storage device 204 of the client PC 101 in order to upload the content 406.

Further, the user can upload the content 406 of the document by a folder (content group) storing the data including the text and the image. The content 406 is applied to the plurality of different types of products associated with the event. When each product or template includes the different number of content pieces (placeholders) on which the layout is performed, the user can specify the content for each product or template from among the same uploaded content group.

Check boxes 403 receive, from the user, a selection of the event for which the printed document is used. The user performs the input into the check box 403 to specify the usage of the printed document. The content 406 is applied to the plurality of different types of products associated with the event. In other words, the user can perform an uploading operation only once for the plurality of different types of products, thereby decreasing the workload of the print order. When the user uploads the content 406 into any of the regions 402, the event represented by the region 402 where the content 406 is uploaded may be automatically specified.

An OK button 404 stores the content 406 uploaded by the user and the selection state of the check box 403, and ends the screen. A back button 405 abandons the content 406 uploaded by the user and the selection state of the check box 403, and ends the screen.

In step S707, the client PC 101 determines whether the user has operated the display screen. When the user has operated the OK button 404, the processing proceeds to step S708. When the user has operated the back button 405, information about the operation of the back button 405 is transmitted to the web server 102 as a request. Then, the processing returns to the above-described step S701, and the client PC 101 displays the screen 301 again.

A flowchart of steps 5708 to 5711 illustrates processing performed via the screen 307. In step S708, processing is started. The web browser running on the client PC 101 transmits to the web server 102 a request notifying the user's input via the screen 304. The web server 102 stores the input in the RAM 202 or the external storage device 204 as session information.

In step S709, when the web server 102 determines that the event is selected with reference to the session information, the web server 102 acquires a design theme list from the design theme table 515 stored in the external storage device 204. Based on the design theme table 515, the web server 102 creates a response for displaying the design theme list.

Based on the session information, the web server 102 may change the design theme to be selected according to the determined event (usage). In this case, with reference to the table data in which the event and the design theme are associated with each other, the web server 102 creates a response for displaying the design theme list associated with the selected event. With this arrangement, the design theme appropriate for the determined usage of the printed document can be recommended to the user.

In step S710, the web browser running on the client PC 101 receives the response from the web server 102, converts the response into the format that can be displayed on the screen, and then displays the converted response.

FIG. 4B illustrates an example of a screen for displaying the design theme list illustrated on the screen 307 in detail. The screen 407 is an example of the screen for selecting the design theme illustrated on the screen 307. Regions 408 display information about the design theme, which is stored in the design theme table 515.

Check boxes 409 receive, from the user, a selection of the design theme when the content is printed. The user performs the input to the check box 409 using the pointing device 207 to select the design theme so that the design and the taste can be uniformly applied to the plurality of types of the selected products.

An OK button 410 stores the selection state of the check box 409, and ends the screen. A back button 411 abandons the selection state of the check box 409, and ends the screen.

In step S711, the client PC 101 determines whether the user has operated the display screen. When the user has operated the OK button 410, the processing proceeds to step S712.

When the user has operated the back button 411, information about the operation of the back button 411 is transmitted to the web server 102 as a request. The processing returns to the above-described step S704, and the client PC 101 displays the screen 304 again.

Since the design theme selected via the screen 407 can be applied to all products to be ordered, the same design and the same taste can be uniformly applied to the plurality of different types of products. In other words, when ordering the plurality of types of products, the template including the design and the taste having uniformity can be readily selected, thereby decreasing the work of the print order. Further, the layout template including the design and the taste according to the design theme selected via the screen 407 can be suggested to the user.

A flowchart of steps S712 to S717 illustrates processing performed via the screen 309. In step S712, processing is started. The web browser running on the client PC 101 transmits to the web server 102 a request notifying the user's input via the screen 309 or the screen 314. The web server 102 stores the input in the RAM 202 or the external storage device 204 as session information.

In step S713, with reference to the selected content of the event stored in the session information, the web server 102 acquires a product list associated with the event from the table 514.

In step S714, with reference to the table 514, the web server 102 acquires a print ticket list associated with each product acquired in step S713. The web server 102 creates a response from the information acquired in steps 5713 and 5714.

In step S715, the web browser running on the client PC 101 receives the response from the web server 102, converts the product list acquired from the response into the format that can be displayed on the screen, and then displays the converted product list. Further, in step S716, similarly to step S715, the print ticket list acquired from the response is displayed.

FIGS. 4C to 4E illustrate examples of the screen 309 in detail.

A screen 412 illustrated in FIG. 4C is an example of the screen for selecting the products illustrated in the screen 309. Regions 413 display product information and display the products acquired in step S713. The regions 413 also function as layout buttons for shifting the screen 412 to the screen 314 for selecting the layout of the products.

Drop down list boxes 414 receive a selection of the print ticket from the user. Check boxes 415 receive a selection of the product from the user.

An OK button 416 stores the selection states of the check box 415 and the drop down list box 414, and ends the screen. A back button 417 abandons the selection content of the check box 415 and the drop down list box 414, and ends the screen.

FIG. 4D illustrates an example for displaying the drop down list box 414 in a drop down state, where the user can perform the selection from among a plurality of print tickets. Herein, FIG. 4C illustrates a case where “sport” is selected as an event, and the product to be displayed differs depending on the selection result of the event. For example, when the “business” event is selected as an event, the different types of products are displayed as illustrated in FIG. 4E.

As described above, the user selects the usage of the printed document, and the product to be suggested can be changed according to the usage. Therefore, the user selects the product according to the suggested usage, thereby improving the convenience of the usage and the efficiency of the print order conducted by the user. Further, the processing for ordering the plurality of different types of associated print products can be performed all at once.

In step S717, the client PC 101 determines whether the user has operated the display screen. When the user has operated the OK button 416, the processing proceeds to step S722. When the user has operated the back button 417, information about the operation of the back button 417 is transmitted to the web server 102 as a request. Subsequently, the processing returns to step S708, and the client PC 101 receives the request and displays the screen 307 again. Further, when the user operates any of the regions 413, which are the layout buttons, the processing proceeds to step S718.

A flowchart of steps S718 to S721 illustrates processing performed via the screen 314. In step S718, processing is started. The web browser running on the client PC 101 transmits to the web server 102 a request notifying the user's input via the screen 309. The web server 102 stores the input in the RAM 202 or the external storage device 204 as session information.

In step S719, the web server 102 acquires selection content of products and design themes stored in the session information. The web server 102 acquires the layout template list associated with the selection content from the table 517, and then creates a response.

In step S720, the web browser running on the client PC 101 receives the response from the web server 102, converts the response into the format that can be displayed on the screen, and then displays the converted response.

FIG. 6A illustrates an example of the display on the screen 314 in detail. A screen 601 is an example of the screen for selecting the layout illustrated on the screen 314. Regions 602 display information about the layout result. Herein, the template used for the layout corresponds to the design theme selected via the screen 307 and the product selected via the screen 309. Further, regarding the other product operated and selected via the screen 309, the template corresponding to the same design theme is suggested. Therefore, the user can readily and uniformly apply the same design and the same taste to the plurality of different types of print products.

The regions 602 also function as buttons for determining the selection (third selection) of the layout from among the suggested layout candidates. As described above, using the template associated with the selected design theme, a plurality of layout results is suggested as candidates. Therefore, while applying the design and the taste having uniformity to the plurality of types of products, the user can select his or her favorite layout.

The screen 601 may be shifted to a screen (not illustrated) for specifying the details of the layout by pressing the button 602. Via the screen, the user can perform the layout in detail, for example, changing and specifying the content on which the layout is performed from the uploaded content group to a placeholder.

With this configuration, when the number of content pieces (placeholder) on which the layout is to be performed for each product or template is different, the user can specify the content from among the same uploaded content group for each product or template. Therefore, the user can apply the same content to the plurality of types of print products and also specify the content appropriate for each product or template, thereby improving the convenience of the usage for the user.

In step S721, the client PC 101 determines whether the user has operated the button 602 for determining the layout. When the user has operated the button 602 for determining the layout, the processing returns to step S712. In step S712, the web browser running on the client PC 101 transmits to the web server 102 the selected layout information as a request. The web server 102 stores the selected layout information in the RAM 202 or the external storage device 204 as session information.

A flowchart of steps S722 to S725 illustrates processing performed via the screen 316. In step S722, processing is started. The web browser running on the client PC 101 transmits to the web server 102 a request notifying the user's input via the screen 309. The web server 102 stores the input in the RAM 202 or the external storage device 204 as session information.

In step S723, the web server 102 acquires order information including the selection content of the event, product, design theme, print ticket, and layout stored in the session information. Further, with reference to the table 514, the web server 102 acquires the price information associated with the acquired event, product, and print ticket. The web server 102 creates a response from the information described above.

In step S724, the web browser running on the client PC 101 receives the response from the web server 102, converts the response into the format that can be displayed on the screen, and then displays the converted response.

FIG. 6B illustrates an example of the screen 316 in detail. A screen 603 is an example of the screen 316. On the screen 603, the user can input the number of copies to be ordered and confirm the price of the product. Regions 604 display the selection results (order content) of the product and of the print ticket. Regions 606 display the price of the product.

Edit boxes 605 receive input of the number of copies of the product. An OK button 607 stores the input content of the edit boxes 605, and ends (confirm the order) the screen. A back button 608 abandons the input content of the edit boxes 605, and ends the screen. As described above, when the processing ends in step S725, the processing in the print order processing performed by the client PC 101 and the web server 102 is completed.

Herein, when the OK button 607 is operated, the order is confirmed. Upon receiving the request indicating the order confirmation, the web server 102 creates a print job from the content of the request, and transmits the print job to the printing company server 103. The printing company server 103 creates the print data from the received print job, and the printer 104 prints the print data.

According to the present exemplary embodiment as described above, the print product associated with the usage (event) of the printed document is suggested to the user, and thus one print order can deal with the plurality of different types of products. In other words, the plurality of different types of products can be ordered all at once, thereby decreasing the work for ordering the plurality of different types of products.

Further, the same design and the same taste (design theme) are uniformly applied to the plurality of different types of products. Accordingly, the work for selecting the template including the design and the taste that match each of the plurality of different types of products is decreased, thereby improving the convenience of the usage for the user. Furthermore, since the same content can be applied to the templates including the plurality of different types of products, the uploading work can be simplified.

According to the present exemplary embodiment, the screen is dynamically created by the web server 102 with reference to the table data. Further, an HTML file for displaying each screen is previously held and transmitted to the web server 102 as a response.

According to the first exemplary embodiment, when the event is selected, the plurality of types of products associated with the event are suggested. Further, the design theme is set so that the same design, the same taste and the same uploaded content can be applied to the plurality of types of products to be uniformly treated. According to the present exemplary embodiment, the design theme depending on the event is set as a default so that the plurality of types of products can be uniformly treated.

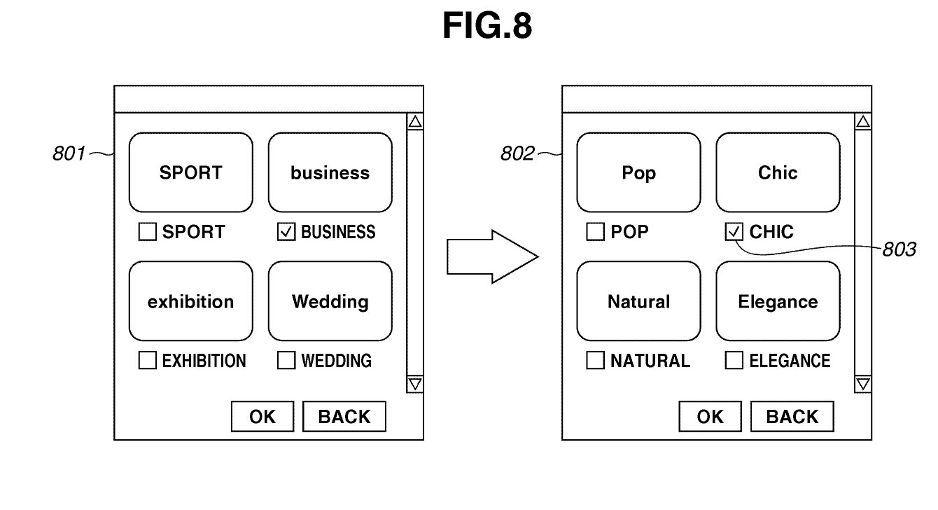

FIG. 8 illustrates an example of display on the screen 304 and the screen 307 according to the present exemplary embodiment. A screen 801 is an example of the screen 304 and a screen 802 is an example of the screen 307. If the user selects the business event via the screen 801, next, on the screen 802 to which the screen 801 shifts, “chic” is selected as a design theme of the default.

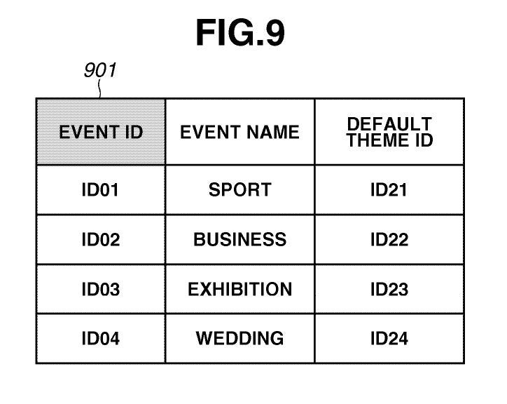

FIG. 9 illustrates a table 901 acquired by extending the event table 511 illustrated in FIG. 5. As illustrated in FIG. 9, the design theme ID of the default is associated with each event. The design theme ID is an external key of a main key of the design theme table 515.

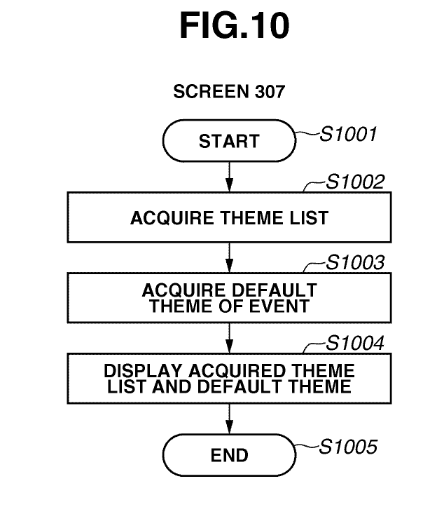

FIG. 10 is a flowchart illustrating processing performed in a second exemplary embodiment. The flowchart performed in the second exemplary embodiment is used in place of the flowchart of steps S708 to S711 performing the processing for displaying the design theme list in the first exemplary embodiment.

In step S1001, the processing is started. The web browser running on the client PC 101 transmits to the web server 102 a request notifying the user's input via the screen 602. The web server 102 stores the input in the RAM 202 or the external storage device 204 as session information.

In step S1002, the web server 102 acquires a design theme list from the design theme table 515.

In step S1003, with reference to the selection content of the event stored in the session information, the web server 102 acquires a design theme ID of the default associated with the event from the table 901. The web server 102 creates a response which indicates that the default design theme has been previously selected as illustrated on the screen 802 from the information acquired in steps S1002 and S1003.

In step S1004, the web browser running on the client PC 101 receives the response from the web server 102, converts the response into the format that can be displayed on the screen, and then displays the converted response. In step S1005, the processing ends.

With the processing described above, when the event is selected, the design theme to be selected as the default can be set. Thus, the user does not have to select the design theme, thereby improving the convenience of the usage for the user and the efficiency of the work.

Herein, the screen 307 displays a state where the design theme of the default is selected. However, the screen 307 may be skipped and the screen 304 may shift to the screen 309 in the state where the design theme of the default is selected. The screen 309 is a product selecting screen.

According to the second exemplary embodiment, when the event is selected, the design theme selected as a default can be set. In a third exemplary embodiment, a configuration (design theme determination processing) in which the design theme set by the default is dynamically changed will be described.

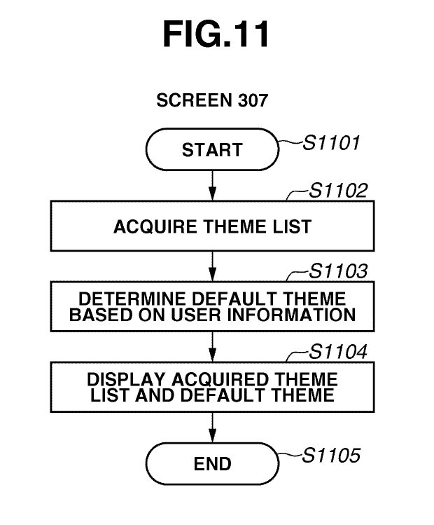

FIG. 11 is a flowchart illustrating design theme determination processing according to the present exemplary embodiment. The flowchart in the third exemplary embodiment is used in place of the flowchart of steps S1001 to S1005 for performing the processing for displaying the design theme list and the design theme of the default in the second exemplary embodiment.

In step S1101, the processing is started. The web browser running on the client PC 101 transmits to the web server 102 a request notifying the user's input via the screen 602. The web server 102 stores the input in the RAM 202 or the external storage device 204 as session information.

In step S1102, the web server 102 acquires a design theme list from the design theme table 515. In step S1103, with reference to the content stored in the session information or to the other database, the web server 102 determines a design theme ID of the default. The web server 102 creates a response from the information acquired in step S1102 and determined in step S1103.

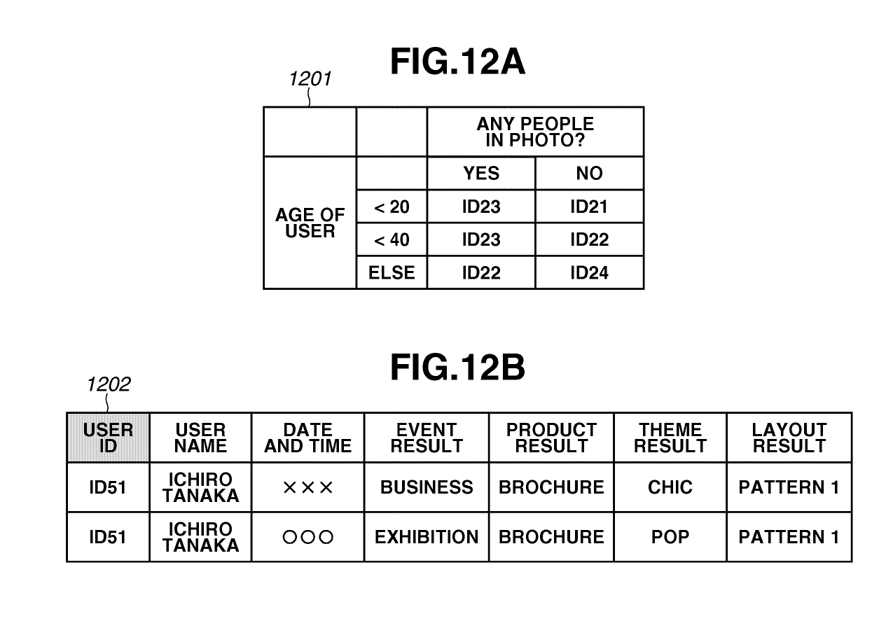

FIG. 12A illustrates an example of a rule for determining the design theme ID of the default. According to this example, the CPU 201 of the web server 102 analyzes the uploaded content and determines whether there are any people in a picture. With reference to a user information database (not illustrated) managed by the web server 102 as user information, the CPU 201 acquires an age of the user.

Based on the result of analyzing the content, the user information and such, if the uploaded content is a picture including people and the user is in his or her thirties, the design theme of the default is determined as ID23 (natural).

According to the present exemplary embodiment, whether any people are included as the analysis result and the age of the user as the user information are illustrated. However the rule for determining the design theme ID of the default is not limited thereto. For example, the analysis result of the content includes the number of pictures, a size of a picture, date and time for shooting a picture, and whether a document is included. The user information includes sex, residential area, occupation, and hobby of the user. The arbitrary number of arbitrary analysis results and the arbitrary number of pieces of user information can be combined to be used.

A data table 1201 is stored in the external storage device 204 of the web server 102 and, based on the rule, the web server 102 specifies a design theme ID of the default and determines a design theme.

In step S1104, the web browser running on the client PC 101 receives the response from the web server 102, converts the response into the format that can be displayed on the screen, and then displays the converted response. In step S1105, the processing ends.

With the processing described above, the design theme selected as the default can be dynamically determined based on the analysis result of the content and the user information. Therefore, the design theme that seems to be appropriate for the user can be set to recommend the design theme to the user.

With reference to the order information conducted by the user in the past, the design theme of the default may be set to more reflect the user's taste. FIG. 12B is a data table illustrating which design theme is selected to which event in the order information conducted by the user in the past.

A data table 1202 is stored by the external storage device 204 of the web server 102, and updated as needed. Using the order information, when the user selects a certain event, the design theme selected to the event in the past can be determined as the default. When there is a plurality of candidates, a method for selecting the design theme that has been selected most in the past or selected last can be determined.

With the above-described processing, when determining the design theme of the default, based on the selection of the event or of the design theme included in the order information of the user in the past, the design theme that seems to suit the user's taste can be recommended.

According to the present exemplary embodiment, the web server 102 holds all information, and with reference to the information based on the web to print program, the web server 102 creates a response to the client PC 101. In addition, the necessary information may be transmitted from the web server 102 to the client PC 101 so that the client PC 101 can perform the processing.

Further, according to the present exemplary embodiment, the usage of the printed document is specified as the event of sport or business. However the present invention is not limited thereto. For example, a type of business, a group to which the user belongs, or a community may be specified to determine the usage of the printed document. The type of business, the group, or the community is associated with the product having a high usage frequency so that the plurality of types of products can be uniformly treated.

Furthermore, the present invention can be realized by performing the processing described below. Software (program) for realizing functions of the above-described exemplary embodiment is provided to a system or an apparatus via a network or various storage media. A computer (or, CPU or micro processing unit (MPU)) of the system or of the apparatus reads the program to execute the processing.

As described above, the exemplary embodiment according to the present invention, the print product associated with the usage (event) of the printed document is suggested to the user, and thus one print order can deal with the plurality of different types of products. In other words, the plurality of different types of products can be ordered all at once, thereby decreasing the work for ordering the plurality of different types of products.

According to the exemplary embodiments of the present invention, to the plurality of different types of products, the same design and the same taste are uniformly adopted. Therefore, the work for selecting the template including the design and the taste that match each of the plurality of different types of products can be decreased, thereby improving the convenience of the usage for the user. Furthermore, since the same content can be applied to the templates of the plurality of different types of products, the uploading work can be simplified.

By performing the loading work once using the same content, the user can perform the layout on the plurality of different types of products, thereby simplifying the work of the print order.

Since the user can conduct the print order from the usage of the printed document, the print product depending on the usage can be readily selected. Further, the plurality of types of print products associated with the usage can be simply ordered. Furthermore, since the product associated with the usage of the printed document is suggested, the product having a prospective demand can be suggested to the user. Therefore, since the print product can be recommended, the user has a high chance of ordering another product that is unplanned to evoke a print demand.

The user can select either of the method for conducting an order from the print product and the method for conducting an order from the event (usage). In other words, when a plurality of types of products needs to be uniformly treated, the method for conducting an order from the event (usage) may be selected, while the method for conducting an order from the product may be selected, when the desired print product is obvious and only one type. In other words, the order method according to the user's wish can be provided.

By suggesting the design theme associated with the event (usage of the printed document), the design theme appropriate for the usage of the printed document can be recommended to the user.

By setting the design theme selected as the default when selecting an event, the user does not have to select any design theme, thereby improving the convenience of the usage for the user and the efficiency of the work.

The design and the taste selected as the default can be dynamically changed according to the information about the user. Thus, the design and the taste can be recommended according to each user.

An order history of the user in the past is stored, and, based on the order history, the design and the taste of the default is dynamically changed so that a design theme that seems to suit the user's taste can be recommended, thereby improving recommendation processing with a high accuracy for the user.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-215088 filed Sep. 27, 2010, which is hereby incorporated by reference herein in its entirety.

What is claimed is:

1. A layout system that performs a layout on a printed document, the layout system comprising:
a determination unit configured to determine a usage of the printed document;
a first selection unit configured to select a design theme to be applied to a plurality of types of print products associated with the determined usage; and
a layout unit configured to perform the layout on content of a document using a template associated with the design theme selected for the print product.

2. The layout system according to claim 1, further comprising a second selection unit configured to select at least one of the plurality of types of print products associated with the usage,
wherein the layout unit performs the layout on the content of the document using the template associated with the design theme determined for the print product selected by the second selection unit.

3. The layout system according to claim 2, wherein the layout unit performs, using same content uploaded by a user, the layout on the plurality of types of print products selected by the second selection unit.

4. The layout system according to claim 1, wherein the first selection unit selects the design theme associated with the usage as a default.

5. The layout system according to claim 1, further comprising a theme determination unit configured to determine a design theme that is to be a default based on at least any one of an analysis result of the content, user information, and information about a user's orders in the past,
wherein the first selection unit selects the design theme determined by the theme determination unit as the default.

6. The layout system according to claim 1, further comprising:
a first specification unit configured to cause a user to specify whether to select the print product without selecting the usage or to select the usage and then to select a print product associated therewith; and
a second specification unit configured to, if it is specified by the first specification unit that the usage has been selected and then the print product associated therewith is selected, cause the user to specify the usage of the printed document,
wherein the determination unit determines the usage specified by the second specification unit as a usage of the printed document.

7. The layout system according to claim 1,
wherein the design theme selected by the first selection unit is associated with the usage determined by the determination unit.

8. The layout system according to claim 2, further comprising:
an order unit configured to receive a print order of the print product selected by the second selection unit; and
a print unit configured to, based on the print order received from the order unit, perform printing of the layout performed by the layout unit on the print product.

9. The layout system according to claim 8, further comprising a third selection unit configured to select any one of a plurality of layouts on which the layout is performed by the layout unit using a plurality of templates,
wherein the print unit prints the layout selected by the third selection unit.

10. An information processing apparatus that performs layout on a printed document, the information processing apparatus comprising:
a determination unit configured to determine a usage of the printed document;
a first selection unit configured to select a design theme to be applied to a plurality of types of print products associated with the determined usage; and
a layout unit configured to perform the layout on content of a document using a template associated with the design theme selected for the print product.

11. A layout method for performing layout on a printed document, the layout method comprising:
determining a usage of the printed document;
selecting a design theme to be applied to a plurality of types of print products associated with the determined usage; and
performing a layout on content of a document using a template associated with the design theme selected for the plurality of types of print products.

12. A storage medium that stores a computer-readable program for causing a computer to perform a layout method for performing layout on a printed document, the layout method comprising:
determining a usage of the printed document;
selecting a design theme to be applied to a plurality of types of print products associated with the determined usage; and
performing a layout on content of a document using a template associated with the design theme selected for the plurality of types of print products.
